(19) United States
(12) Patent Application Publication
(10) Pub. No.: US 2025/0172311 A1
(43) Pub. Date: May 29, 2025

(54) ENVIRONMENT CONTROL SYSTEM, ENVIRONMENT CONTROL METHOD, AND ENVIRONMENT CONTROL PROGRAM

(71) Applicant: OMRON Corporation, Kyoto-shi, KYOTO (JP)

(72) Inventors: Shoya MURAKAMI, Kyoto-shi, KYOTO (JP); Masahiko OGAWA, Kyoto-shi, KYOTO (JP); Takenori HATSUDA, Kyoto-shi, KYOTO (JP); Ayana TSUJI, Kyoto-shi, KYOTO (JP)

(21) Appl. No.: 18/859,606

(22) PCT Filed: May 2, 2023
(86) PCT No.: PCT/JP2023/017204

§ 371 Date: Oct. 24, 2024

(30) Foreign Application Priority Data
May 27, 2022 (JP) 2022-087106

(51) Int. Cl. F24F 11/64; F24F 11/00; F24F 110/10; F24F 110/20; F24F 110/40; F24F 130/30; F24F 130/40

(52) U.S. Cl. CPC F24F 11/64; F24F 11/0008; F24F 2110/10; F24F 2110/20; F24F 2110/40; F24F 2130/30; F24F 2130/40

(57) ABSTRACT

The environment control system includes a first control unit that controls an environment in a room where an individual stays, a measurement unit that measures a value indicating the environment in the room, an environment model that is constructed using, as input data, a correspondence relationship between a behavior pattern in response to a stress of the individual and the value indicating the environment and outputs a target value for suppressing the stress of the individual when a time-series change in the value indicating the environment is input, and a second control unit that controls the first control unit so that the value indicating the environment measured by the measurement unit approaches the target value acquired by inputting the time-series change in the value indicating the environment into the environment model.

### TECHNICAL FIELD

The present invention relates to an environment control system, an environment control method, and an environment control program.

### BACKGROUND ART

Techniques for controlling an environment of a space in which a person works have been proposed. For example, a system has been proposed in which physiological information of a subject is acquired by a sensor or the like and an air conditioner or the like is controlled in response to the acquired physiological information (see, for example, Patent Documents 1 to 3).

### CITATION LIST

### Patent Literature

Patent Document 1: JP 2000-354943 A
Patent Document 2: JP 2007-151933 A
Patent Document 3: JP 2020-113025 A

### SUMMARY OF INVENTION

### Technical Problem

However, in the conventional technology, the air conditioner or the like is controlled after the physiological information has changed. Thus, even when it is attempted to achieve an environment in which an individual staying in a room does not feel stress, the control of the air conditioner or the like is executed after the change occurs in the physiological information of the individual, that is, after the individual feels stress, and the control of an indoor environment has been left behind.

It is an object of one aspect of the disclosed technology to provide an environment control system that can achieve the indoor environment in which the stress received by the individual is suppressed as much as possible.

### Solution to Problem

One aspect of the disclosed technology is exemplified by an environment control system as follows. The environment control system includes a first control unit that controls an environment in a room where an individual stays, a measurement unit that measures a value indicating the environment in the room, an environment model that is constructed using, as input data, a correspondence relationship between a behavior pattern in response to a stress of the individual and the value indicating the environment and outputs a target value for suppressing the stress of the individual when a time-series change in the value indicating the environment is input, and a second control unit that controls the first control unit so that the value indicating the environment measured by the measurement unit approaches the target value acquired by inputting the time-series change in the value indicating the environment into the environment model.

According to the environment control system, by inputting the time-series change in the value indicating the environment into the environment model, the target value for suppressing the stress of the individual can be acquired. Then, by controlling the first control unit so that the value indicating the environment measured by the measurement unit approaches the target value, it is possible to achieve the indoor environment in which the stress received by the individual is suppressed as much as possible.

In the environment control system, the value indicating the environment may include a room temperature in the room, the measurement unit may include a temperature sensor that measures the room temperature, the first control unit may include an air conditioner that controls the room temperature in the room, and the environment model may include a room temperature model that is constructed using, as input data, a correspondence relationship between the behavior pattern in response to the stress of the individual and the room temperature and outputs a target value of the room temperature for suppressing the stress of the individual when a time-series change in the room temperature is input. The second control unit may control the air conditioner so that the room temperature measured by the temperature sensor approaches the target value of the room temperature acquired by inputting the time-series change in the room temperature into the room temperature model. By controlling the air conditioner in this way, it is possible to maintain a room temperature at which the individual is less likely to feel stress.

In the environment control system, the value indicating the environment may include humidity in the room, the measurement unit may include a humidity sensor that measures the humidity, the first control unit may include a humidifier that controls the humidity in the room, and the environment model may include a humidity model that is constructed using, as input data, a correspondence relationship between the behavior pattern in response to the stress of the individual and the humidity and outputs a target value of the humidity for suppressing the stress of the individual when a time-series change in the humidity is input. The second control unit may control the humidifier so that the humidity measured by the humidity sensor approaches the target value of the humidity acquired by inputting the time-series change in the humidity into the humidity model. By controlling the humidifier in this way, it is possible to maintain humidity at which the individual is less likely to feel stress.

In the environment control system, the value indicating the environment may include illuminance in the room, the measurement unit may include an illuminance sensor that measures the illuminance, the first control unit may include an illuminating instrument that controls the illuminance in the room, and the environment model may include an illuminance model that is constructed using, as input data, a correspondence relationship between the behavior pattern in response to the stress of the individual and the illuminance and outputs a target value of the illuminance for suppressing the stress of the individual when a time-series change in the illuminance is input. The second control unit may control the illuminating instrument so that the illuminance measured by the illuminance sensor approaches the target value of the illuminance acquired by inputting the time-series change in the illuminance into the illuminance model. By controlling the illuminating instrument in this way, it is possible to maintain illuminance at which the individual is less likely to feel stress.

In the environment control system, the value indicating the environment may include a value indicating a volume of sound in the room, the measurement unit may include a microphone that measures the volume of the sound, the first control unit may include a sound insulation unit for suppressing entry of sound from the outside into the room, and the environment model may include a noise model that is constructed using, as input data, a correspondence relationship between the behavior pattern in response to the stress of the individual and the value indicating the volume of the sound and outputs a target value of the value indicating the volume of the sound for suppressing the stress of the individual when a time-series change in the value indicating the volume of the sound is input. The second control unit may control the sound insulation unit so that the value indicating the volume of the sound measured by the microphone approaches the target value of the value indicating the volume of the sound acquired by inputting the time-series change in the value indicating the volume of the sound into the noise model. By controlling the sound insulation unit in this way, it is possible to suppress the volume of the sound entering from the outside within a range in which the individual is less likely to feel stress.

In the environment control system, the value indicating the environment may include an atmospheric pressure in the room, the measurement unit may include an atmospheric pressure sensor that measures the atmospheric pressure, the first control unit may include an atmospheric pressure adjustment instrument that controls the atmospheric pressure in the room, and the environment model may include an atmospheric pressure model that is constructed using, as input data, a correspondence relationship between the behavior pattern in response to the stress of the individual and the atmospheric pressure and outputs a target value of the atmospheric pressure for suppressing the stress of the individual when a time-series change in the atmospheric pressure is input. The second control unit may control the atmospheric pressure adjustment instrument so that the atmospheric pressure measured by the atmospheric pressure sensor approaches the target value of the atmospheric pressure acquired by inputting the time-series change in the atmospheric pressure into the atmospheric pressure model. By controlling the atmospheric pressure adjustment instrument in this way, it is possible to maintain an atmospheric pressure at which the individual is less likely to feel stress.

The disclosed technology can also be understood from the aspects of an environment control method and an environment control program.

### Advantageous Effects of Invention

According to the disclosed technology, it is possible to achieve an indoor environment in which stress received by an individual is suppressed as much as possible.

### BRIEF DESCRIPTION OF DRAWINGS

FIG. 1 is a diagram illustrating an example of an environment control system according to an embodiment.

FIG. 2 is a diagram schematically illustrating network connection of each system included in the environment control system.

FIG. 3 is a diagram illustrating schematic configurations of functional units included in a control device.

FIG. 4 is a diagram illustrating an example of a correspondence relationship between a measurement value and a behavior pattern used for constructing an environment model.

FIG. 5 is a schematic diagram illustrating the entire processing flow of the environment control system according to the embodiment.

FIG. 6 is a first diagram illustrating an example of a processing flow for constructing the environment model.

FIG. 7 is a second diagram illustrating an example of the processing flow for constructing the environment model.

FIG. 8 is a diagram illustrating an example of a processing flow of indoor environment control processing by the control device.

### DESCRIPTION OF EMBODIMENTS

### Application Example

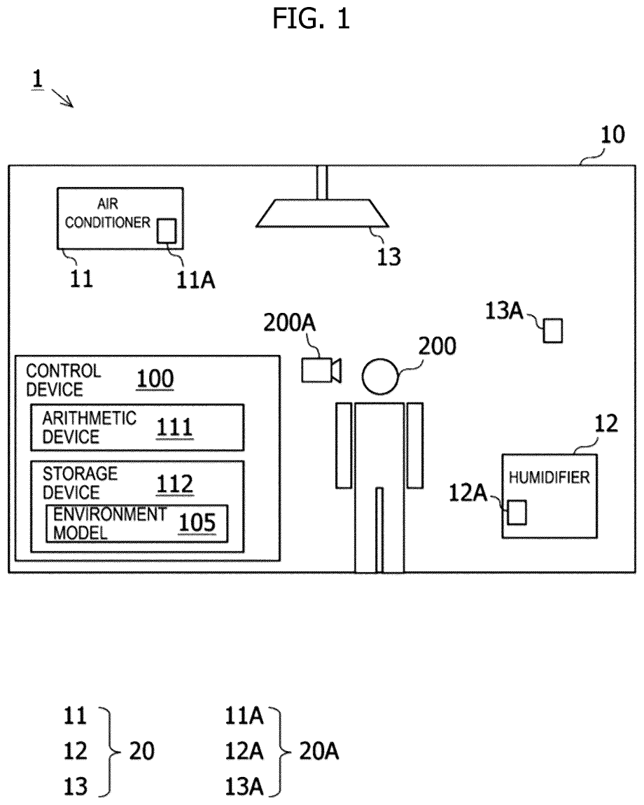

Hereinafter, an application example of the present invention will be described with reference to the drawings. The present invention is applied to an environment control system 1, an example of which is illustrated in FIG. 1. The environment control system 1 includes an air conditioner 11, a temperature sensor 11A, a humidifier 12, a humidity sensor 12A, an illuminating instrument 13, an illuminance sensor 13A, a camera 200A, and a control device 100. The air conditioner 11, the humidifier 12, and the illuminating instrument 13 are also collectively referred to as an environmental device 20. The temperature sensor 11A, the humidity sensor 12A, and the illuminance sensor 13A are also collectively referred to as an environmental sensor 20A. The environmental device 20 and the environmental sensor 20A are installed in a room 10. However, an installation location of the control device 100 is not limited as long as the control device 100 can communicate with the environmental device 20 and the environmental sensor 20A. The environment control system 1 is an example of an “environment control system”. The environmental device 20 is an example of a “first control unit”. The control device 100 is an example of a “second control unit”. The environmental sensor 20A is an example of a “measurement unit”.

Based on an image of a user 200 captured by the camera 200A, the control device 100 acquires a behavior pattern performed when the user 200 feels stress. The behavior pattern performed when the user 200 feels stress may be referred to as a “habit” performed by the user 200 when the user 200 feels stress. The control device 100 constructs an environment model 105 by machine learning using, as input data, a correspondence relationship between a time-series change in a measurement value measured by the environmental sensor 20A and a behavior pattern performed when the user 200 feels stress. When a measurement value by the environmental sensor 20A is input, the constructed environment model 105 outputs a target value for maintaining, in the room 10, an environment in which the user 200 does not feel stress. The environment model 105 is an example of an “environment model”. The user 200 is an example of an “individual”.

The control device 100 controls the environmental device 20 by using a target value acquired by inputting a time-series change in the measurement value measured by the environmental sensor 20A in a predetermined period into the environment model 105. The environment control system 1 is a system that achieves, in the room 10, an environment in which the stress felt by the user 200 is suppressed by controlling the environmental device 20 by using the time-series change in the measurement value measured by the environmental sensor 20A in the predetermined period and the environment model 105. The measurement value measured by the environmental sensor 20A is an example of a “value indicating the environment”.

### Embodiments

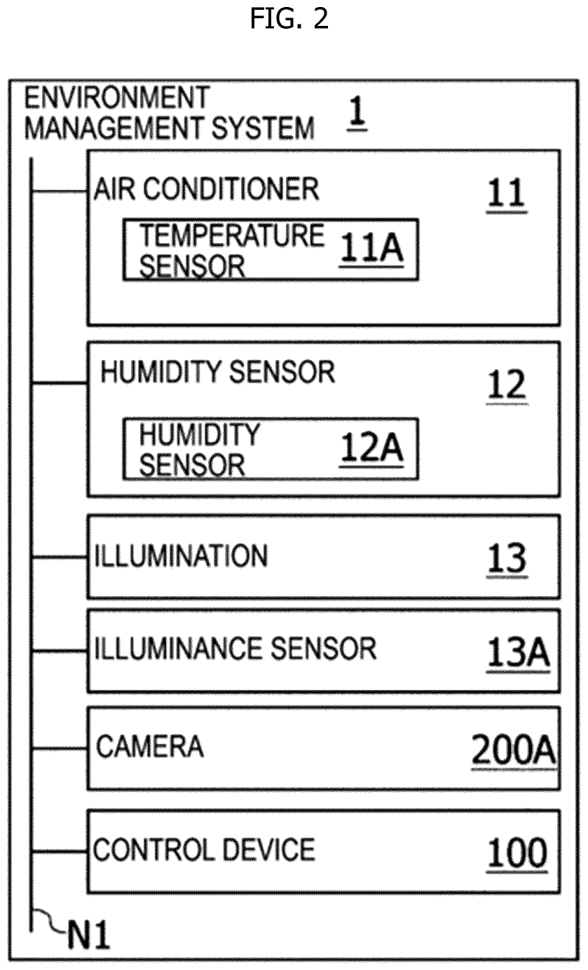

Embodiments will be further described with reference to the drawings. FIG. 1 is a diagram illustrating an example of the environment control system 1 according to the embodiment. FIG. 2 is a diagram schematically illustrating network connection of each system included in the environment control system 1. In the environment control system 1, the air conditioner 11, the humidifier 12, the illuminating instrument 13, the illuminance sensor 13A, the camera 200A, and the control device 100 are communicably connected to each other by a network N1.

The room 10 is a place where the user 200 stays and performs business, learning, and the like. The room 10 may be, for example, a room in which the user 200 performs remote work. The room in which the remote work is performed may be, for example, a room of the user 200 at home owned by the user 200 or a private room provided for the remote work.

The air conditioner 11 controls the room temperature in the room 10. The air conditioner 11 includes the temperature sensor 11A, and the temperature sensor 11A measures the room temperature in the room 10. The air conditioner 11 performs, for example, a cooling operation or a heating operation while monitoring the room temperature in the room 10 measured by the temperature sensor 11A so that the room temperature in the room 10 becomes a room temperature instructed by the control device 100. The air conditioner 11 transmits the room temperature measured by the temperature sensor 11A to the control device 100 via the network N1.

The humidifier 12 controls the humidity in the room 10. The humidifier 12 includes the humidity sensor 12A, and the humidity sensor 12A measures the humidity in the room 10. The humidifier 12 humidifies the air in the room 10 while monitoring the humidity in the room 10 measured by the humidity sensor 12A so that the humidity becomes humidity instructed by the control device 100. When the operation of the humidifier 12 is stopped, the humidity in the room 10 decreases due to inflow of air outside the room 10 or the like. The humidifier 12 transmits the humidity measured by the humidity sensor 12A to the control device 100 via the network N1.

The illuminating instrument 13 is an illuminating instrument using a fluorescent lamp, a light emitting diode (LED), or the like for illuminating the inside of the room 10. The illuminating instrument 13 can change illuminance in response to an instruction from the control device 100. The illuminance sensor 13A measures illuminance in the room 10. The air conditioner 11, the humidifier 12, and the illuminating instrument 13 are also collectively referred to as an environmental device 20. The temperature sensor 11A, the humidity sensor 12A, and the illuminance sensor 13A are also collectively referred to as an environmental sensor 20A.

The camera 200A captures an image of the upper body including the face of the user 200. The camera 200A transmits the captured image to the control device 100 via the network N1.

The network N1 is a network that connects a computer so that the computer can perform mutual communication. The network N1 is, for example, a local area network (LAN). The network N1 may be a wireless network or a wired network.

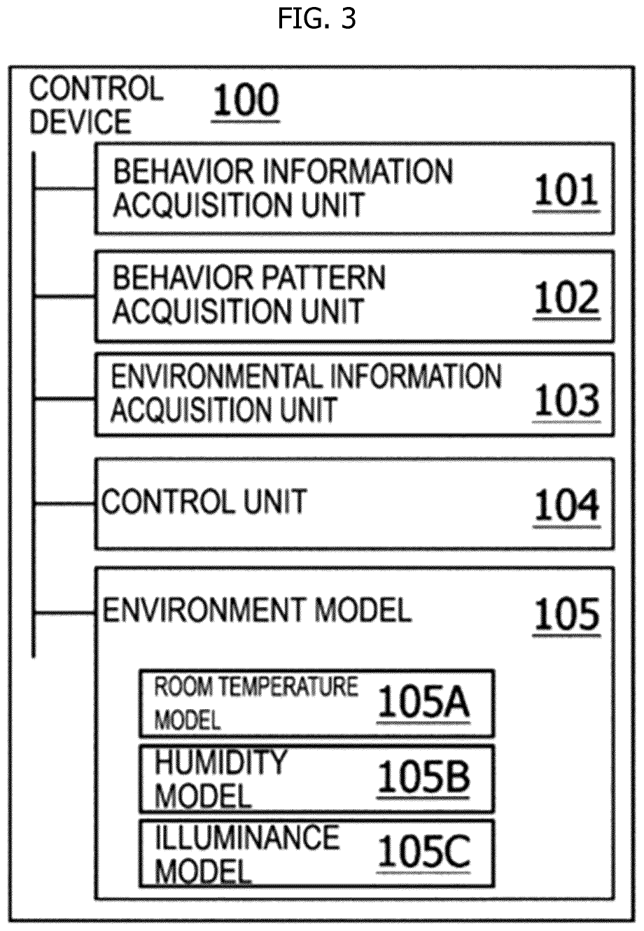

The control device 100 acquires, via the network N1, the measurement value measured by the environmental sensor 20A and controls the environmental device 20 by using the acquired measurement value. FIG. 3 is a diagram illustrating schematic configurations of functional units included in the control device 100. The control device 100 can be regarded as a computer including an arithmetic device 111, a storage device 112, and the like. The functional units illustrated in FIG. 3 are achieved by, for example, executing a program stored in the storage device 112 by the arithmetic device 111. The control device 100 includes a behavior information acquisition unit 101, a behavior pattern acquisition unit 102, an environmental information acquisition unit 103, a control unit 104, and the environment model 105, but may include other functional units.

The behavior information acquisition unit 101 acquires an image captured by the camera 200A. The behavior information acquisition unit 101 detects the positions of a face, an eye, and a hand of the user 200 from the acquired image.

The behavior pattern acquisition unit 102 acquires the behavior pattern of the user 200 based on the positions of the face and the hand detected by the behavior information acquisition unit 101. For example, when the hand of the user 200 is at the position of the head of the user 200 in the image acquired by the behavior information acquisition unit 101, the behavior pattern acquisition unit 102 recognizes that the user 200 is scratching the head. For example, when the hand of the user 200 is at the position of the eye of the user 200 in the image acquired by the behavior information acquisition unit 101, the behavior pattern acquisition unit 102 recognizes that the user 200 is rubbing the eye. The behavior pattern of scratching the head or rubbing the eye is considered to be a behavior pattern occurring when the user 200 feels some stress.

The environmental information acquisition unit 103 acquires, via the network N1, the measurement value measured by the environmental sensor 20A. The environmental information acquisition unit 103 constructs the environment model 105 by associating the acquired measurement value with the behavior pattern performed by the user 200 at the timing when the measurement value is acquired. The constructed environment model 105 is stored in the storage device 112.

The environment model 105 is a model constructed by machine learning using, as input data, a correspondence relationship between the measurement value measured by the environmental sensor 20A and the behavior pattern of the user 200 at the time when the measurement value is measured. The environment model 105 includes a room temperature model 105A, a humidity model 105B, and an illuminance model 105C. The room temperature model 105A is constructed, for example, by machine learning using, as input data, a correspondence relationship between the room temperature measured by the temperature sensor 11A and the behavior pattern of the user 200. For example, the humidity model 105B is constructed by machine learning using, as input data, s correspondence relationship between the humidity measured by the humidity sensor 12A and the behavior pattern of the user 200. For example, the illuminance model 105C is constructed by machine learning using, as input data, a correspondence relationship between the illuminance measured by the illuminance sensor 13A and the behavior pattern of the user 200.

When a time-series change in the measurement value measured by the environmental sensor 20A in a predetermined period is input, the environment model 105 constructed in this manner outputs a target value for controlling the environmental device 20 so that the user 200 does not feel stress.

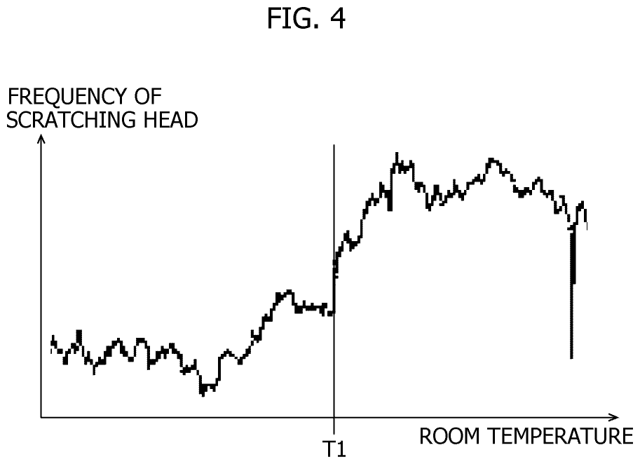

FIG. 4 is a diagram illustrating an example of a correspondence relationship between a measurement value and a behavior pattern used for constructing the environment model 105. In FIG. 4, the vertical axis represents the frequency of scratching the head, which is an example of the behavior pattern, and the horizontal axis represents the room temperature. In the example of FIG. 4, it can be understood that the frequency of scratching suddenly increases from a room temperature T1 as a boundary. Since it is considered that the behavior pattern of scratching the head occurs when the user 200 feels some stress as described above, it is considered that the user 200 feels strong stress when the temperature exceeds the room temperature T1. Thus, when the time-series change in the room temperature is input, the room temperature model 105A outputs a target value of the room temperature for controlling the air conditioner 11 so that the room temperature in the room 10 does not exceed the room temperature T1 at which the user 200 feels strong stress. The relationship between the behavior pattern of scratching the head and the room temperature has been described as an example in FIG. 4. The same applies to other behavior patterns and other measurement values (humidity and illuminance).

For example, when a time-series change in the room temperature measured by the temperature sensor 11A in a predetermined period is input, the environment model 105 outputs a target value of the room temperature to the control unit 104. For example, when a time-series change in the humidity measured by the humidity sensor 12A in a predetermined period is input, the environment model 105 outputs a target value of the humidity to the control unit 104. For example, when a time-series change in the illuminance measured by the illuminance sensor 13A in a predetermined period is input, the environment model 105 outputs a target value of the illuminance to the control unit 104.

The control unit 104 acquires, via the network N1, the measurement value measured by the environmental sensor 20A. For example, the control unit 104 accesses the storage device 112 in which the environment model 105 is stored to input the time-series change in the acquired measurement value in a predetermined period into the environment model 105, thereby acquiring a target value that does not cause the user 200 to feel stress from the environment model 105. The control unit 104 controls the environmental device 20 by using the acquired target value. By controlling the environmental device 20 in this way, the stress of the user 200 performing business, hobby, or the like in the room 10 received from the surrounding environment is reduced.

For example, the control unit 104 acquires the room temperature measured by the temperature sensor 11A from the air conditioner 11. Then, the control unit 104 inputs a time-series change in the room temperature in a predetermined period into the room temperature model 105A. The control unit 104 acquires the target value of the room temperature output by the room temperature model 105A. The control unit 104 may control the air conditioner 11 so that the room temperature in the room 10 approaches the target value of the room temperature acquired from the room temperature model 105A.

For example, the control unit 104 acquires the humidity measured by the humidity sensor 12A from the humidifier 12. Then, the control unit 104 inputs a time-series change in the humidity in a predetermined period into the humidity model 105B. The control unit 104 acquires the target value of the humidity output by the humidity model 105B. The control unit 104 may control the humidifier 12 so that the humidity in the room 10 approaches the target value of the humidity acquired from the humidity model 105B.

For example, the control unit 104 acquires the illuminance measured by the illuminance sensor 13A from the illuminance sensor 13A. Then, the control unit 104 inputs a time-series change in the illuminance in a predetermined period into the illuminance model 105C. The control unit 104 acquires the target value of the illuminance output by the illuminance model 105C. control unit 104 may control the illuminating instrument 13 so that the illuminance in the room 10 approaches the target value of the illuminance acquired from the illuminance model 105C.

### Processing Flow

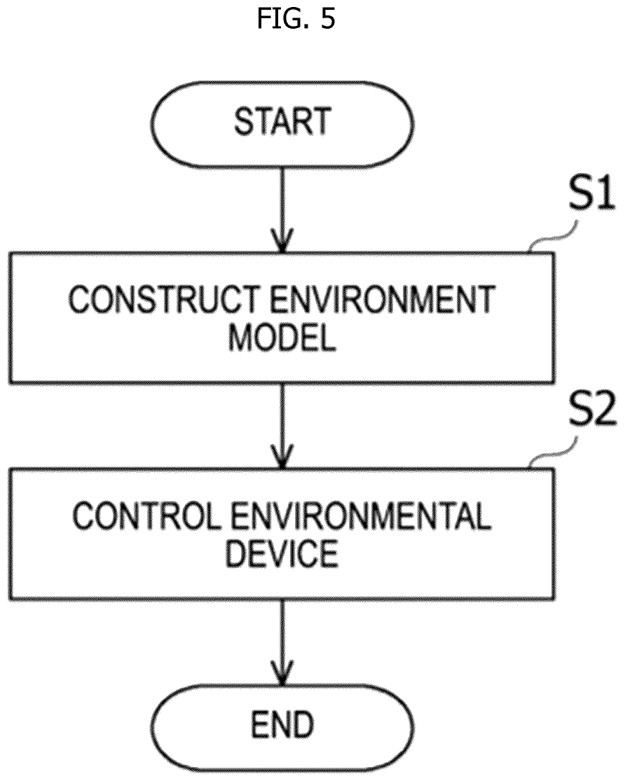

FIG. 5 is a schematic diagram illustrating the entire processing flow of the environment control system 1 according to the embodiment. The outline of the entire processing flow of the environment control system 1 will be described below with reference to FIG. 5.

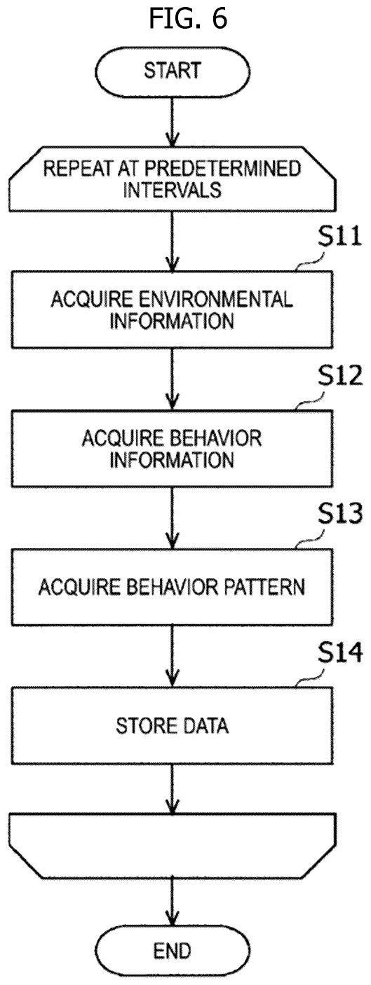

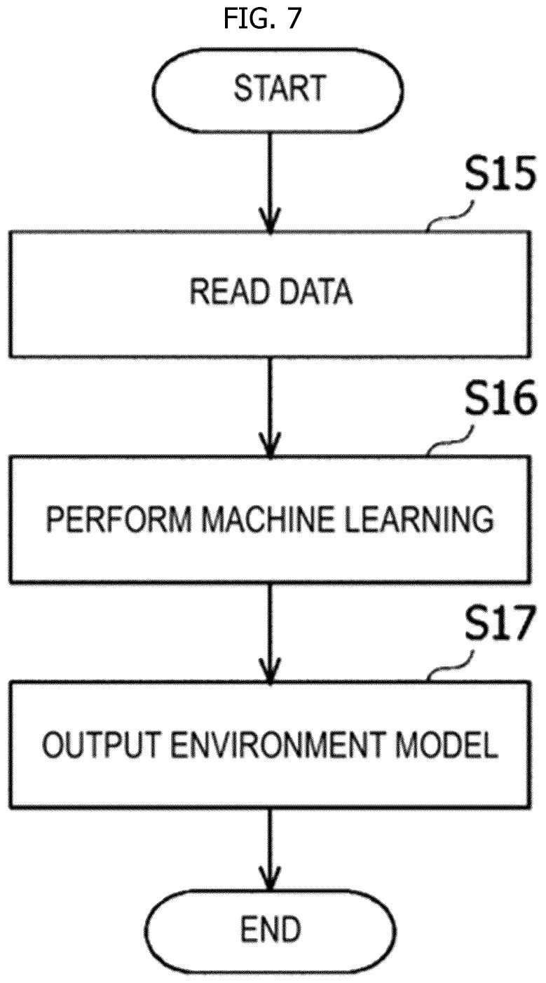

In step S1, the control device 100 constructs the environment model 105 by using, as input data, the correspondence relationship between the measurement value measured by the environmental sensor 20A and the behavior pattern of the user 200 at the time when the measurement value is measured. The details of step S1 will be described later with reference to FIGS. 6 and 7.

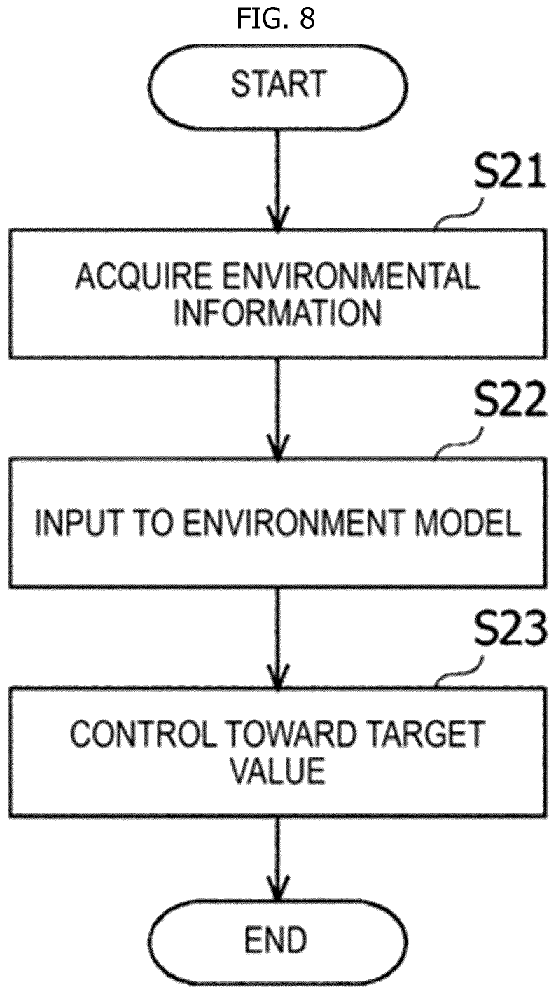

In step S2, the control device 100 uses the environment model 105 constructed in step S1 and the measurement value measured by the environmental sensor 20A to control the environmental device 20 so that the environment of the room 10 does not cause the user 200 to feel stress. The details of step S2 will be described later with reference to FIG. 8.

FIGS. 6 and 7 are diagrams each illustrating an example of a processing flow for constructing the environment model 105. FIGS. 6 and 7 illustrate the details of the processing of step S1 in FIG. 5. FIG. 6 illustrates a processing flow of processing of acquiring a measurement value and a behavior pattern used for constructing the environment model 105. FIG. 7 illustrates a processing flow of processing of constructing the environment model 105 by using the measurement value and the behavior pattern acquired in the processing of FIG. 6. First, an example of the processing flow of processing for acquiring the measurement value and the behavior pattern used for constructing the environment model 105 will be described with reference to FIG. 6.

In step S11, the environmental information acquisition unit 103 acquires the measurement value measured by the environmental sensor 20A.

In step S12, the behavior information acquisition unit 101 acquires the image captured by the camera 200A. The behavior information acquisition unit 101 detects the positions of the face and hand of the user 200 from the acquired image. In step S13, the behavior pattern acquisition unit 102 acquires the behavior pattern of the user 200 based on the positions of the face and the hand detected by the behavior information acquisition unit 101.

In step S14, the environmental information acquisition unit 103 associates the measurement value acquired in step S11 and the behavior pattern acquired in step S13 with each other to store thereof in the storage device 112. The processing from step S11 to step S14 is repeatedly executed at predetermined intervals.

Subsequently, with reference to FIG. 7, an example of a processing flow of processing of constructing the environment model 105 by using the measurement value and the behavior pattern acquired in the processing of FIG. 6.

In step S15, the environmental information acquisition unit 103 reads the correspondence relationship between the measurement value stored in the storage device 112 in step S14 of FIG. 6 and the behavior pattern acquired in step S13.

In step S16, the environmental information acquisition unit 103 constructs the environment model 105 by machine learning using, as input data, the correspondence relationship read from the storage device 112 in step S15.

In step S17, the environmental information acquisition unit 103 stores the environment model 105 constructed in step S16 in the storage device 112.

FIG. 8 is a diagram illustrating an example of a processing flow of indoor environment control processing by the control device 100. Hereinafter, an example of the processing flow of the indoor environment control processing by the control device 100 will be described with reference to FIG. 8.

In step S21, the control unit 104 continuously acquires the measurement value measured by the environmental sensor 20A for a predetermined period.

In step S22, the control unit 104 accesses the storage device 112 in which the environment model 105 is stored to input the time-series change in the measurement value in a predetermined period acquired in step S21 into the environment model 105. For example, the control unit 104 inputs a time-series change in the room temperature measured by the temperature sensor 11A into the room temperature model 105A. The control unit 104 acquires the target value of the room temperature from the room temperature model 105A, as a response to the input of the time-series change in the room temperature. For example, the control unit 104 inputs a time-series change in the humidity measured by the humidity sensor 12A into the humidity model 105B. The control unit 104 acquires the target value of the humidity from the humidity model 105B as a response to the input of the time-series change in the humidity. For example, the control unit 104 inputs a time-series change in the illuminance measured by the illuminance sensor 13A into the illuminance model 105C. The control unit 104 acquires the target value of the illuminance from the illuminance model 105C as a response to the input of the time-series change in the illuminance.

In step S23, the control unit 104 controls the environmental device 20 so that the measurement value measured by the environmental sensor 20A approaches the target value acquired in step S22. For example, the control unit 104 controls the air conditioner 11 so that the room temperature in the room 10 approaches the target value of the room temperature acquired in step S22. For example, the control unit 104 controls the humidifier 12 so that the humidity in the room 10 approaches the target value of the humidity acquired in step S22. For example, the control unit 104 controls the illuminating instrument 13 so that the illuminance in the room 10 approaches the target value of the illuminance acquired in step S22.

### Advantageous Effects of Embodiments

In the embodiments described above, when the time-series change in a measurement value measured by the environmental sensor 20A in a predetermined period is input, the environment model 105 that outputs the target value that does not cause the user 200 to feel stress is constructed. Then, the control device 100 inputs the time-series change in the measurement value measured by the environmental sensor 20A in a predetermined period into the environment model 105 to acquire the target value. The control device 100 controls the environmental device 20 so that the measurement value measured by the environmental sensor 20A approaches the target value. Thus, according to the present embodiment, the environment in the room 10 can be set to an indoor environment in which the stress received by the user 200 can be suppressed as much as possible.

For example, in an office of a company, the room temperature, humidity, and illuminance may be controlled so that an environment suitable for work is maintained. However, when the user 200 performs work at home owned by the user 200 or the like by remote work or the like, the indoor environment of the room where the work is performed is not always a preferable environment for the work due to the circumstances of the individual home or the like. According to the environment control system 1 of the present embodiment, the environment model 105 suitable for suppressing the stress of the user 200 is constructed based on the correspondence relationship between the behavior pattern performed when the user 200 feels stress and the measurement value measured by the environmental sensor 20A. Then, by controlling the environmental device 20 by using the environment model 105 and the measurement value measured by the environmental sensor 20A, it is possible to achieve the indoor environment in which the stress received by the user 200 can be suppressed as much as possible even in a case where work is performed at home or the like by the remote work or the like.

In the present embodiment, for example, the time-series change in the room temperature measured by the temperature sensor 11A is input into the room temperature model 105A to acquire a target value of the room temperature that does not cause the user 200 to feel stress. The control device 100 controls the air conditioner 11 so that the room temperature measured by the temperature sensor 11A approaches the target value of the room temperature. Thus, according to the present embodiment, it is possible to maintain the room temperature at which the stress received by the user 200 can be suppressed as much as possible.

In the present embodiment, for example, the time-series change in the humidity measured by the humidity sensor 12A is input into the humidity model 105B to acquire the target value of the humidity that does not cause the user 200 to feel stress. The control device 100 controls the humidifier 12 so that the humidity measured by the humidity sensor 12A approaches the target value of the humidity. Thus, according to the present embodiment, it is possible to maintain the humidity at which the stress received by the user 200 can be suppressed as much as possible.

In the present embodiment, for example, the time-series change in the illuminance measured by the illuminance sensor 13A is input into the illuminance model 105C to acquire the target value of the illuminance that does not cause the user 200 to feel stress. The control device 100 controls the illuminating instrument 13 so that the illuminance measured by the illuminance sensor 13A approaches the target value of the illuminance. Thus, according to the present embodiment, it is possible to maintain the illuminance at which the stress received by the user 200 can be suppressed as much as possible.

### Modified Example

In the embodiments described above, the behavior pattern of rubbing the eye and the behavior pattern of scratching the head are given as the behavior pattern indicating the stress of the user 200, but the behavior pattern indicating the stress of the user 200 is not limited to these. Examples of the behavior pattern indicating the stress of the user 200 include a strength of tapping the keyboard of the computer and displacement of a position of the face. Here, in a case where the strength of tapping the keyboard of the computer by the user 200 is acquired, for example, a microphone may be employed instead of the camera 200A.

In the embodiments described above, the air conditioner 11, the humidifier 12, and the illuminating instrument 13 are exemplified as the environmental device 20, but the environmental device 20 is not limited thereto. Examples of the environmental device 20 include a curtain having a variable sound insulation property and an atmospheric pressure adjustment instrument that adjusts the atmospheric pressure in the room 10.

The curtain having the variable sound insulation property suppresses entry of a noise from the outside into the room 10. Examples of the curtain having the variable sound insulation property include a curtain in which a motor is incorporated in a curtain rail and a degree of opening of the curtain is controlled by driving the motor according to an instruction from the control device 100. By controlling the degree of opening of the curtain, the sound insulation property of the curtain can be varied. Here, in a case where the curtain having the variable sound insulation property is used, a microphone may be employed as the environmental sensor 20A, and the environment model 105 may be constructed using a measurement value indicating the volume of sound generated in the room 10 measured by the microphone and the behavior pattern of the user 200. The curtain having the variable sound insulation property is an example of a “sound insulation unit”. The environment model 105 constructed using the measurement value indicating the volume of the sound generated in the room 10 and the behavior pattern of the user 200 is an example of a “noise model”.

Examples of the atmospheric pressure adjustment instrument include a compressor that takes outside air into the room 10. By driving the compressor in accordance with an instruction from the control device 100, outside air can be taken into the room 10 to increase the atmospheric pressure in the room 10, or the air in the room 10 can be discharged to decrease the atmospheric pressure in the room 10. Here, in a case where the atmospheric pressure adjustment instrument is used, the atmospheric pressure sensor may be adopted as the environmental sensor 20A, and the environment model 105 may be constructed using the measurement value of the atmospheric pressure in the room 10 measured by the atmospheric pressure sensor and the behavior pattern of the user 200. The environment model 105 constructed using the measurement value of the atmospheric pressure and the behavior pattern of the user 200 is an example of an “atmospheric pressure model”.

In the embodiment, the temperature sensor 11A is built in the air conditioner 11. However, the temperature sensor 11A may be a device separated from the air conditioner 11. In the embodiment, the humidity sensor 12A is built in the humidifier 12. However, the humidity sensor 12A may be a device separated from the humidifier 12. In the embodiment, the illuminance sensor 13A is a device separated from the illuminating instrument 13. However, the illuminance sensor 13A may be built in the illuminating instrument 13.

In the embodiment, the environment model 105 is stored in the storage device 112 of the control device 100. However, the storage device in which the environment model 105 is stored is not limited to the storage device 112. The environment model 105 may be stored in a storage device outside the control device 100 as long as the storage device is accessible from the control device 100.

The above-described embodiments and modifications can be combined.

### Computer-Readable Recording Medium

An information processing program for causing a computer or any other machine or device (hereinafter referred to as a computer or the like) to implement any of the functions described above may be recorded in a recording medium readable by the computer or the like. The functions can be provided by causing the computer or the like to load the program from the recording medium and to execute the program.

Here, the recording medium readable by the computer or the like refers to a recording medium capable of storing information such as data or programs by an electrical, magnetic, optical, mechanical, or chemical action in such a manner that the computer or the like can read the information from the recording medium. Examples of such recording medium that is removable from the computer or the like include a flexible disk, a magneto-optical disk, a compact disc read only memory (CD-ROM), a compact disc recordable (CD-R), a compact disc rewritable (CD-RW), a digital versatile disc (DVD), a Blu-ray disc (BD), a digital audio tape (DAT), a 8 mm tape, a flash memory, an external hard disk drive, and a solid state drive (SSD). Examples of a recording medium fixed to the computer or the like include a built-in type hard disk drive, an SSD, and a ROM.

### Supplementary Note 1

An environment control system (1) including
a first control unit (20) that controls an environment in a room (10) where an individual (200) stays,
a measurement unit (20A) that measures a value indicating the environment in the room (10),
an environment model (105) that is constructed using, as input data, a correspondence relationship between a behavior pattern in response to a stress of the individual (200) and the value indicating the environment and outputs a target value for suppressing the stress of the individual (200) when a time-series change in the value indicating the environment is input, and a second control unit (100) that controls the first control unit (20) so that the value indicating the environment measured by the measurement unit (20A) approaches the target value acquired by inputting the time-series change in the value indicating the environment into the environment model.

### Supplementary Note 2

An environment control method performed by

a computer (100) that controls an environment in a room (10) in which a first control unit (20) that controls the environment in the room (10) where an individual (200) stays and a measurement unit (20A) that measures a value indicating the environment in the room (10) are disposed, the environment control method including
accessing a storage unit (112) that stores an environment model (105) that is constructed using, as input data, a correspondence relationship between a behavior pattern in response to a stress of the individual (200) and the value indicating the environment and outputs a target value for suppressing the stress of the individual (200) when a time-series change in the value indicating the environment is input and
controlling the first control unit (20) so that the value indicating the environment measured by the measurement unit (20A) approaches the target value acquired when the time-series change in the value indicating the environment is input into the environment model (105).

### Supplementary Note 3

Environment control program that causes

a computer (100) that controls an environment in a room (10) in which a first control unit (20) that controls the environment in the room (10) where an individual (200) stays and a measurement unit (20A) that measures a value indicating the environment in the room (10) are disposed, to
access a storage unit (112) that stores an environment model (105) that is constructed using, as input data, a correspondence relationship between a behavior pattern in response to a stress of the individual (200) and the value indicating the environment and outputs a target value for suppressing the stress of the individual (200) when a time-series change in the value indicating the environment is input and
control the first control unit (20) so that the value indicating the environment measured by the measurement unit (20A) approaches the target value acquired when the time-series change in the value indicating the environment is input into the environment model (105).

### DESCRIPTION OF SYMBOLS

1 environment control system
10 room
11 air conditioner
11A temperature sensor
12 humidifier
12A humidity sensor
13 illuminating instrument
13A illuminance sensor
20 environmental device
20A environmental sensor
100 control device
101 behavior information acquisition unit
102 behavior pattern acquisition unit
103 environmental information acquisition unit
104 control unit
105 environment model
105A room temperature model
105B humidity model
105C illuminance model
111 arithmetic device
112 storage device
200 user
200A camera
N1 network

1. An environment control system comprising:
a first control unit configured to control an environment in a room where an individual stays;
a measurement unit configured to measure a value indicating the environment in the room;
an environment model that is constructed using, as input data, a correspondence relationship between a behavior pattern in response to a stress of the individual and the value indicating the environment and outputs a target value for suppressing the stress of the individual when a time-series change in the value indicating the environment is input; and
a second control unit configured to control the first control unit and the value indicating the environment measured by the measurement unit approaches the target value acquired by inputting the time-series change in the value indicating the environment into the environment model.

2. The environment control system according to claim 1, wherein
the value indicating the environment includes a room temperature in the room,
the measurement unit includes a temperature sensor configured to measure the room temperature,
the first control unit includes an air conditioner configured to control the room temperature in the room,
the environment model includes a room temperature model that is constructed using, as input data, a correspondence relationship between the behavior pattern in response to the stress of the individual and the room temperature and outputs a target value of the room temperature for suppressing the stress of the individual when a time-series change in the room temperature is input, and
the second control unit controls the air conditioner and the room temperature measured by the temperature sensor approaches the target value of the room temperature acquired by inputting the time-series change in the room temperature into the room temperature model.

3. The environment control system according to claim 1, wherein
the value indicating the environment includes a humidity in the room,
the measurement unit includes a humidity sensor configured to measure the humidity,
the first control unit includes a humidifier configured to control humidity in the room,
the environment model includes a humidity model that is constructed using, as input data, a correspondence relationship between the behavior pattern in response to the stress of the individual and the humidity and outputs a target value of the humidity for suppressing the stress of the individual when a time-series change in the humidity is input, and
the second control unit controls the humidifier and the humidity measured by the humidity sensor approaches the target value of the humidity acquired by inputting the time-series change in the humidity into the humidity model.

4. The environment control system according to claim 1, wherein
the value indicating the environment includes illuminance in the room,
the measurement unit includes an illuminance sensor configured to measure the illuminance,
the first control unit includes an illuminating instrument configured to control the illuminance in the room,
the environment model includes an illuminance model that is constructed using, as input data, a correspondence relationship between the behavior pattern in response to the stress of the individual and the illuminance and outputs a target value of the illuminance for suppressing the stress of the individual when a time-series change in the illuminance is input, and
the second control unit controls the illuminating instrument and the illuminance measured by the illuminance sensor approaches the target value of the illuminance acquired by inputting the time-series change in the illuminance into the illuminance model.

5. The environment control system according to claim 1, wherein
the value indicating the environment includes a value indicating a volume of sound in the room,
the measurement unit includes a microphone configured to measure the volume of the sound,
the first control unit includes a sound insulation unit configured to suppress entry of sound from the outside into the room,
the environment model includes a noise model that is constructed using, as input data, a correspondence relationship between the behavior pattern in response to the stress of the individual and the value indicating the volume of the sound and outputs a target value of the value indicating the volume of the sound for suppressing the stress of the individual when a time-series change in the value indicating the volume of the sound is input, and
the second control unit controls the sound insulation unit and the value indicating the volume of the sound measured by the microphone approaches the target value of the value indicating the volume of the sound acquired by inputting the time-series change in the value indicating the volume of the sound into the noise model.

6. The environment control system according to claim 1, wherein
the value indicating the environment includes an atmospheric pressure in the room,
the measurement unit includes an atmospheric pressure sensor configured to measure the atmospheric pressure,
the first control unit includes an atmospheric pressure adjustment instrument configured to control the atmospheric pressure in the room,
the environment model includes an atmospheric pressure model that is constructed using, as input data, a correspondence relationship between the behavior pattern in response to the stress of the individual and the atmospheric pressure and outputs a target value of the atmospheric pressure for suppressing the stress of the individual when a time-series change in the atmospheric pressure is input, and
the second control unit controls the atmospheric pressure adjustment instrument and the atmospheric pressure measured by the atmospheric pressure sensor approaches the target value of the atmospheric pressure acquired by inputting the time-series change in the atmospheric pressure into the atmospheric pressure model.

7. An environment control method performed by a computer configured to control an environment in a room in which a first control unit configured to control the environment in the room where an individual stays and a measurement unit configured to measure a value indicating the environment in the room are disposed, the environment control method comprising:
accessing a storage unit storing an environment model that is constructed using, as input data, a correspondence relationship between a behavior pattern in response to a stress of the individual and the value indicating the environment and outputs a target value for suppressing the stress of the individual when a time-series change in the value indicating the environment is input; and
controlling the first control unit and the value indicating the environment measured by the measurement unit approaches the target value acquired when the time-series change in the value indicating the environment is input into the environment model.

8. A non-transitory computer readable medium storing an environment control program configured to cause a computer configured to control an environment in a room in which a first control unit configured to control the environment in the room where an individual stays and a measurement unit configured to measure a value indicating the environment in the room are disposed, to
access a storage unit storing an environment model that is constructed using, as input data, a correspondence relationship between a behavior pattern in response to a stress of the individual and the value indicating the environment and outputs a target value for suppressing the stress of the individual when a time-series change in the value indicating the environment is input; and
control the first control unit and the value indicating the environment measured by the measurement unit approaches the target value acquired when the time-series change in the value indicating the environment is input into the environment model.
